(19) United States
(12) Patent Application Publication
(10) Pub. No.: US 2005/0203681 A1
(43) Pub. Date: Sep. 15, 2005

(54) Internet-enabled, auto-networking, wireless, sensor-capable, specific geographic location marker based communications network system

(76) Inventor: John Scott Minor JR., Cleveland, OH (US)

Correspondence Address: John Scott Minor, Jr., 1599 Maywood Road, Cleveland, OH, 44121, US

(21) Appl. No.: 10/798,764

(22) Filed: Mar. 11, 2004

(51) Int. Cl. H04Q 7/20

(52) U.S. Cl. 701/23

(57) ABSTRACT

The invention provides an Internet-enabled, auto-networking, wireless, sensor-capable, specific geographic location marker based communications network system which broadly and economically deploys a wired and wireless, geographic position specific marker based, communications network technology to form a framework or infrastructure through which a multitude of these marker systems can communicate globally. The invention gathers and transmits or receives: wireless bioinformatics data from living organisms in real time; route and environmental data for real time autonomous systems control; plat data for automating tax assessment; topographic and survey control point data for automating photogrammetry; intelligent survey monument deployment for Internet based land surveying; and environmental, industrial, commercial, residential, medical and security sensor based data in real time. The invention utilizes necessary sensor and position (GPS) electronics and units are deployed along natural and man-made geographic features. Deployment is via field survey or through attachment to a present survey boundary marker or roadside pole.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR COMPUTER PROGRAM

Not Applicable

### BACKGROUND OF THE INVENTION

1. Field of the Invention

The surveying and photogrammetry industries have many problems with manual information gathering, flow, and analysis, with multiple redundant manual steps or stages in each process. Field monuments, which run the gambit of a pile of stones to a metal pin, can be lost over time. Surveyor notes are written in the field and kept with the surveyor, so they lose the link to their monument and spatial location. Plat and deed data are usually kept with a county auditor or recorder, so this presents a third location of critical information that is not directly tied to its spatial position.

Photogrammetry requires control points and topographic information in order to develop maps from photos. This is done with a field survey team, so the cost and time involved is considerable. In addition, manual field information must be reentered several times which increases the chances of error.

The larger issue for many additional problems today—which will be direct beneficiaries of my invention—stems from a lack of an economical highly granular wireless ad hoc communications infrastructure.

Once the above needs are established—which I further address in the following paragraphs, the question becomes what is not anticipated, rendered obvious, suggested, or even implied by the prior art, either alone or in any combination thereof, for an invention that will address these primary survey and larger issue problems.

Bioinformatics (internally or externally positioned electronic sensor based information about a living organism) information must now be compiled on a body-wearable data storage device for later transmission by some electronics means—removing the possible life saving capability of real-time, fully mobile and wireless data transmission of vital organic data.

Autonomous systems, especially motor vehicles, require the use of sensor fusion, which is the compilation of various on-board sensor systems for the detection of path and impediment. A combination of LIDAR, RADAR, and stereo-vision cameras are used to allow an autonomous unit to “see”. However, no data is being sent from sensors in the unit's environment—all data comes from on-board systems, and this produces limitations. LIDAR (laser light based) is made less than optimal with issues like blowing sand or dirt, darkness, rain and snow. The stereo-vision system, also relying on light, has the same problem. RADAR can work through these issues, but a clear and detailed picture of some object is very difficult—removing the capability of an onboard decision support software system from knowing if the obstacle is perhaps cardboard or a human.

Plat data must be compiled from a field survey with corner pins or monuments defining the property and/or boundary line. Details of the survey process are kept in field notes, and all of the information on the plat must be written in a deed and recorded with the county recorder's office for use in assessing tax amounts from the county auditor's office. This manual process is both time consuming and error prone which removes the completeness and trustworthiness of maps while also requiring the property owner to pay for the survey work and for the repeated errors of the tax assessment process.

Photogrammetry, or the use of photo information for making maps, requires specific coordinate control points around which to build a datum, remove the out-of-focus issues as one leaves the center of each film shot, and define the map scale. This is an arduous, costly, and time-consuming task.

Survey monuments or corner pins have a tendency to be altered over time, and they can be difficult to find again, especially in more rural settings. In addition, field notes can be misplaced or destroyed.

Micro and nano sized sensors are becoming inexpensive and very useful in all areas of our lives—from monitoring our body functions to monitoring our industrial operations, commercial operations, environment and security, but the wireless transmission of their information in real time is a major economic and technological hurdle.

2. Description of the Prior Art

Low Power Ad Hoc Network Wireless System

With the development of microelectromechanical systems (MEMS) and nano scale electronics, very small low power ad hoc network protocol/radio systems are now available. An example is U.S. patent application Ser. No. 20030099221 Network Protocol from Millennial Net which describes one such protocol and network structure. Other examples include manufacturers University of California, Berkeley (“Tiny OS”) and Crossbow Technologies, Inc. (“Smart Dust”). The various protocols and structures have specific strengths and weaknesses which lend themselves to specific applications. Each communications scenario will dictate which approach is most cost effective. The present invention uses the known technology of low-power ad hoc network wireless systems to improve upon current technology used in surveying, photogrammetry, bioinformatics, autonomous vehicle control, tax data development, and sensors.

Global Positioning System (GPS)

The US global positioning system (GPS) of satellites has long been available to the public for detailed spatial locator requirements (examples include U.S. patent applications Nos.: 20040039855 System and method for precisely locating network devices; 20040039528 Method and apparatus for determining vehicle position on a map; 20040036649 GPS explorer). Ground units use various iterations of GPS circuit technology depending on the accuracy required and the available power for the end unit. However, the result is a geographic location in three dimensional space. The issue is the related supporting data (meta data) about the three dimensional geographic data. As an example, one must know the horizontal and vertical datums upon which the geographic coordinates were developed for a survey based application. This data is an input variable for the ground GPS unit, but is not included in stand-alone spatial locator data. The present invention uses the known technology of global positioning systems to improve upon current technology used in surveying, photogrammetry, bioinformatics, autonomous vehicle control, tax data development, and sensors.

Sensors

Bioinformatics, or the compilation through hardware sensor devices of biological information, environmental sensors, residential, commercial and industrial sensors, security sensors—sensors of every type and description—have a long history. And many of these devices are getting small enough so that they can be implanted (example U.S. patent application Nos. 0040023317 Implantable biosensor from stratified nanostructured membranes, and 20030147451 Amplifier device for sensors) or carried easily. Now that they have become nano in scale and mobile, the issue is how to move their compiled data in real time to a computer for analysis. One such solution is U.S. patent application Ser. No. 20030194350 Public health threat surveillance system, where remote sensing devices, each including a sensor, collect information related to the presence of hazardous agents, e.g., for detecting a bio-toxin. The sensing devices format collected information in a wireless message protocol, e.g., short message service (SMS) and send formatted information. The remote sensing devices may include any adapted (i.e., with a sensor) typical wireless communications device, e.g., a cell phone, a wireless enabled PDA, notebook computer or tablet computer. A health alert processing center (HAPC) receives wireless protocol messages with the hazardous agent information. The HAPC aggregates data from collected SMS messages and selectively distributes response information, e.g., to a higher level HAPC and/or selected connected wireless devices. While this approach would work for the detailed bio-hazard application, it requires the sensor to be located in some mobile communications device like a cell phone or PDA—precluding the ever widening array of sensors that must be located on or in plants, animals, and humans. It also lacks the granularity required for wide-spread (populated to un-populated) compilation and delivery of the data from these new nano-scale, ultra low power, sensor devices. These devices are the future, and a suitable infrastructure to link them is required for everything from industry to medicine to the environment to national security. The present invention uses the known technology of sensor systems to improve upon current technology used in surveying, photogrammetry, bioinformatics, autonomous vehicle control, tax data development, and sensors.

Autonomous Systems

LIDAR (examples include: U.S. Pat. Nos. 6,691,003 Method and device for identifying the state of a system for effecting the automatic longitudinal and/or lateral control of a motor vehicle; 6,687,577 Simple classification scheme for vehicle/pole/pedestrian detection; 6,683,541 Vertical speed indicator and traffic alert collision avoidance system; 6,654,690 Automated method for making a topographical model and related system) uses laser light to scan a scene and build an image from that scan. The system is on-board the autonomous vehicle, but is limited to any conditions that would inhibit the passage of light such as air born sand, dirt, snow or rain. U.S. patent application Ser. No. 20040032972 Digital watermarks for unmanned vehicle navigation, is a method for automated navigation comprising: capturing an image scan of a digital watermark on an object; extracting orientation and location information of an image sensor relative to the object from the digital watermark; performing object identification based on auxiliary information carried in the digital watermark; and using the orientation, location and object identification information to control movement of a vehicle. However, light interruption issues still remain, and the watermark is not flexible. Like a bar code, it also must be remade and repositioned for any change to be reflected. There is no real time parameter to the system.

RADAR (examples include: U.S. Pat. Nos. 6,670,905 Radar warning receiver with position and velocity sensitive functions; 6,693,557 Vehicular traffic sensor; 6,691,074 System for three dimensional positioning and tracking; 6,691,018 Method and system for identifying a lane change) overcomes the light interruption issues of cameras and LIDAR, but it is difficult to make a differentiation between an animate and inanimate object. It, therefore, becomes another on-board input data device for one more small piece of environmental information that must be analyzed as part of the sensor fusing approach to autonomous systems.

Stereo Vision (examples include: U.S. Pat. Nos. 6,690,451 Locating object using stereo vision; 6,683,676 Three-dimensional image capturing device; 6,665,440 System and method for performing corner guided curve matching of multiple images representing a scene; 6,496,755 Autonomous multi-platform robot system) uses two cameras with some distance between them to merge two views of the same object into stereo or three-dimensional form (mimicking how our eyes work). As light is the medium, light quality and interruption inhibit the usefulness of this on-board tool.

Sensor fusing (examples include: U.S. Pat. Nos. 6,042,050 Synthetic discriminant function automatic target recognition system augmented by LIDAR; 6,272,411 Method of operating a vehicle occupancy state sensor system; 5,140,416 System and method for fusing video imagery from multiple sources in real time) is the hardware and software compilation of multiple sensor inputs. This merging allows a more complete environmental picture to be developed on-board the autonomous unit, and allows for higher quality of the overall event. However, this process must rely only on on-board equipment. An environment based wireless sensor communications system of additional environmental data is needed to bring the whole autonomous system to a higher safety level.

Autonomous vehicles (examples include: U.S. Pat. Nos. 6,694,233 System for relative vehicle navigation; 6,678,590 Vehicle navigation system with vision system preprocessor using MPEG encoder; 6,675,074 Method and system for vehicle trajectory estimation) are becoming every more sophisticated and ubiquitous. However, a limiting factor to their widespread use is their inability to “see” safely and in real-time in any environment. This will require a very granular grid of wireless sensor communications field devices that feed data to the unit in real-time from the environment.

Photogrammetry

Photogrammetry (examples include: U.S. Pat. Nos. 6,693,650 Image processing computer system for a photogrammetric analytical measurement; 6,628,803 Device for calculating positional data of standard points of photogrammetric target) requires the use of field control points and topographic check-points as part of the setup and preparation before photos can be taken. This work is done in the field by surveyors. It is manual, time consuming and costly, and the manual aspect requires data to be gathered, transferred to paper and re-input into the photogrammetry system of cameras and map making electronics. This allows for multiple human error issues. An electronic data compilation and transfer process is needed.

Radio Frequency Identification Tags

The use of radio frequency identification systems (RFID) and the use of survey monument systems are known in the prior art. The U.S. patent application Ser. No. 20030234293 Radio frequency identification survey monument system, uses an RFID tag placed inside the plastic cap of a field monument with the primary purpose of being able to again locate the monument during some in-the-field retracement effort. The patent application RFID devices were passive (non-powered), so the reader device was required to excite the tag in order to get any stored data. In addition, the device was “read-only”, and data storage space was confined to a few letters, numbers (UPC as an example), or words. They were not intended for real time or on-line technology or applications. Read distances were also minimal, and if the RFID tag was buried, a metal antenna above ground was required. The present invention uses the known technology of passive and active RFID systems to improve upon current technology used in surveying, photogrammetry, bioinformatics, autonomous vehicle control, tax data development, and sensors.

Surveying Systems

U.S. patent application Ser. No. 20020199018 Mapping physical locations to Web sites deals with the use of a relational database that uses a physical or geographic location as a field name—allowing the user to design a database query based on the geographic location as the search parameter. Relational database design is not part of the present invention.

U.S. Pat. No. 5,734,348 to Aoki, et al discloses a surveying system using GPS receivers. However, the Aoki '348 patent does not store GPS metadata or use RFID technology, and has the further drawback of not being able to store information at the monument site. Further it is not a real-time on-line solution.

U.S. Pat. No. 5,614,913 to Nichols, et al discloses an optimization of survey coordinate transformations that uses GPS for selecting an optimal transformation for purposes of gathering surveying measurements. However, the Nichols '913 patent does not store land surveying data, or meta data about the GPS input variables, and, additionally, does not assist a user in locating a land survey monument in a real-time on-line system.

Similarly, U.S. Pat. No. 5,291,703 to Ziegler discloses a survey monument and improved extraction restriction means therefore that has a simple spring clip extracting means to allow easy removal of rod after rod is driven into the ground. However, the Zeigler '703 patent does not assist a user is locating a land monument, and cannot store data for real-time on-line retrieval.

Lastly, U.S. Pat. No. 6,144,301 to Frieden discloses an electronic tracking tag that may be attached to various types of physical assets to assist in asset identification. However, the Frieden '301 patent does not assist in locating a monument that may be buried, and has the additional deficiency of working only to locate an asset and does not have a feature wherein a reader receives information or data from an electronic tracking tag or in getting survey, GPS meta, and sensor data in a real-time on-line format.

While the above-described devices fulfill their respective, particular objectives and requirements, the aforementioned patents do not describe an Internet-enabled, auto-networking, wireless, sensor-capable, specific geographic location marker based communications network system that transmits and receives valuable information on-line and in real-time.

Therefore, a need exists for a new and improved approach that can be used for transmitting and retrieving valuable information from a real-time on-line distributed marker, sensor and wireless communications network system. In this regard, the present invention substantially fulfills this need. The Internet-enabled, auto-networking, wireless, sensor-capable, specific geographic location marker based communications network system substantially departs from the conventional concepts and designs of the prior art.

### BRIEF SUMMARY OF THE INVENTION

In view of the foregoing disadvantages inherent in the known types of systems now present in the prior art, the present invention provides an improved system. As such, the general purpose of the present invention, which will be described subsequently in greater detail, is to provide a new and improved Internet-enabled, auto-networking, wireless, sensor-capable, specific geographic location marker based communications network system which has all the advantages of the prior art mentioned heretofore and many novel features that result in a system which is not anticipated, rendered obvious, suggested, or even implied by the prior art, either alone or in any combination thereof. The Internet-enabled, auto-networking, wireless, sensor-capable, specific geographic location marker based communications network system has particular utility in broadly and economically deploying wired and wireless, geographic-position-specific-marker, communications network technology to form a framework, fabric or infrastructure through which a multitude of these marker systems can communicate globally. The invention solves the above set of problems by efficiently and cost effectively gathering and transmitting or receiving: wireless bioinformatics data from living organisms in real time; route and environmental data for real time autonomous systems control (such as robotic vehicles); plat data as the basis for tax assessment within the county auditor system of each state; topographic and survey control point data for automating photogrammetry (the making of maps from photos); intelligent survey monument deployment for Internet based land surveying; and environmental, industrial, commercial, residential, medical and security sensor based data in real time. It does this through the use of geographic-position-specific markers and wireless auto-networking communications technology that contain the necessary sensor and position (GPS) electronics and are deployed along natural (lakes, streams, etc.) and man-made (roads, etc) geographic features and with each field survey or through a simple attachment to a present survey boundary marker, such as a correctly located survey monument or roadside pole. Previous to this invention, the above set of circumstances presented an arduous, costly, error prone and time consuming set of tasks, which can now be automated with direct digital input or output.

To attain this, the present invention comprises an Internet-enabled, auto-networking, wireless, sensor-capable, specific geographic location marker based communications network system.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved Internet-enabled, auto-networking, wireless, sensor-capable, specific geographic location marker based communications network system that has all of the advantages of the prior art systems and none of the disadvantages.

It is another object of the present invention to provide a new and improved Internet-enabled, auto-networking, wireless, sensor-capable, specific geographic location marker based communications network system that may be easily and efficiently manufactured and marketed. Manufacturing will be the assembly by attachment, by any means suitable to the surveying, photogrammetry, bioinformatics, autonomous vehicle, plat/tax data, and/or sensor (environmental, industrial, commercial, residential, security, medical) customer, of the wireless communications network and support electronics and all associated software subsystems or subassemblies. Specific manufacturing materials will be dictated by type and purpose of said Internet-enabled, auto-networking, wireless, sensor-capable, specific geographic location marker based communications network system. Electronic units, such as GPS, RFID, power system, data storage, wireless communications nodes and marker shell may be purchased in completed or semi-completed form for assembly into the final marker system unit. Customer requirements will dictate the manufacturing process as well as the amount of electronics that will go into the marker.

An even further object of the present invention is to provide a new and improved Internet-enabled, auto-networking, wireless, sensor-capable, specific geographic location marker based communications network system that has a low cost of manufacture with regard to both materials and labor, and which accordingly is then susceptible of low prices of sale to the consuming public, thereby making such system economically available to the buying public.

Still another object of the present invention is to provide a new Internet-enabled, auto-networking, wireless, sensor-capable, specific geographic location marker based communications network system that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects, other than those set forth above, will become apparent when consideration is given to the following detailed description thereof. Such description makes reference to the annexed drawings wherein:

FIG. 1 is an overview of the preferred embodiment of the Internet-enabled, auto-networking, wireless, sensor-capable, specific geographic location marker based communications network system end node unit constructed in accordance with the principles of the present invention.

FIG. 2 is an overview of the preferred embodiment of the Internet-enabled, auto-networking, wireless, sensor-capable, specific geographic location marker based communications network system router node constructed in accordance with the principles of the present invention.

FIG. 3 is an overview of the preferred embodiment of the Internet-enabled, auto-networking, wireless, sensor-capable, specific geographic location marker based communications network system gateway node constructed in accordance with the principles of the present invention.

FIG. 4 is an overview of the preferred embodiment of the Internet-enabled, auto-networking, wireless, sensor-capable, specific geographic location marker based communications network system Internet gateway or computer control system constructed in accordance with the principles of the present invention.

FIG. 5 is a flow diagram reflecting the two data types: the direct communications data transfer between the network nodes (end node, router node, and gateway node); and the on-board electronics data transfer of information coming from or to the various electronic components of each stand-alone marker. Examples include sensors, RFID, and GPS.

FIG. 6 is a plan view of an example field deployment where the marker units form a grid pattern of some geometric shape. While this is one embodiment example, the final geometric shape shall be defined and dictated by the sensor deployment needs and the wireless communications characteristics of the field deployment environment.

The same reference numerals refer to the same parts throughout the various figures.

### DETAILED DESCRIPTION OF THE INVENTION

In the Background section of this document, I related the issues and problems with the current survey and photogrammetry systems as well as the larger or superset of issues related to the lack of an economical highly granular, ad hoc network, wireless, global communications infrastructure. Example areas within this superset were reviewed. I then reviewed specific needs and the current prior art and shortcomings in these areas. Finally, in this section, I will review my invention which addresses the novel, useful and non-obvious system that fills these needs.

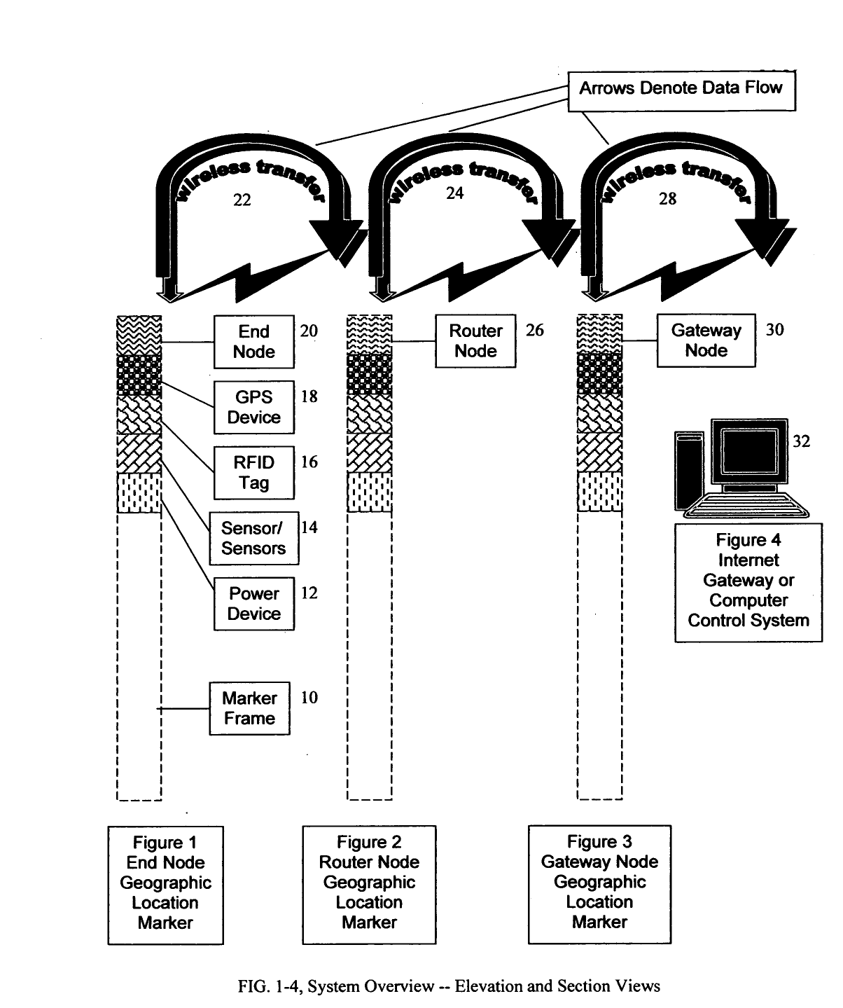

The Internet-enabled, auto-networking, wireless, sensor-capable, specific geographic location marker based communications network system, the preferred embodiment of which is shown in the elevation and section views of FIG. 1, FIG. 2, FIG. 3, and FIG. 4, electronically gathers and/or transmits wireless data with said data being dictated as to content and format by the customer. Examples of data and their communications path include, but are not limited to: electronically gathers and/or transmits wireless bioinformatics data from living organisms in real time; electronically gathers and/or transmits wireless route and environmental data for real time autonomous systems control (such as robotic vehicles); electronically gathers and/or transmits wireless plat data as the basis for tax assessment within the county auditor system of each state; electronically gathers and/or transmits wireless topographic and control point data for automating photogrammetry (the making of maps from photos); electronically gathers and/or transmits wireless environmental, industrial, commercial, residential, medical and/or security sensor based data in real time; and enables wireless intelligent survey monument deployment for Internet based land surveying. The structure of the intelligent real-time on-line monument marker for boundary, personal property, land feature, photogrammetry, tax, survey and topographic data applications provides the economic justification for the initial deployment as well as the invention's preferred embodiment.

Referring now to the drawings, and particularly to FIGS. 1-4, a preferred embodiment of the Internet-enabled, auto-networking, wireless, sensor-capable, specific geographic location marker based communications network system of the present invention is shown.

In FIG. 1-3, the Marker Frame 10 is the structural element that holds all of the devices, and, though it is depicted as a survey monument for the primary embodiment, the actual field deployment requirements will dictate the actual structure that is used. An example would be a survey monument cap. Another example would be a roadside mile marker. A structure of any material—examples including but not limited to rubber, metal, plastic, concrete, metallic or non-metal—can be employed. For example, survey monuments that are currently correctly placed will need a different holding structure than that of a newly manufactured fully electronics-populated survey monument pin as depicted in FIG. 1-3.

In FIG. 1, Power Device 12 is supplied to all of the units shown (examples being, but not limited to, Sensor(s) 14, Radio Frequency Identification (RFID) Tag 16, Global Positioning System (GPS) device 18, and End Node 20) by an on-board power source which includes a battery and a solar cell power/battery charger system. In some examples of marker electronics, power systems will also be an integral part of the electronics subassembly. Integration of the various power systems will be part of the assembly process. Additional power system embodiment examples would include fuel cells for distributed power.

In FIG. 1, Sensor(s) 14 data, RFID Tag 16 data and GPS 18 data and metadata are sent to or received from the End Node 20 via wired or wireless connection. These data are then sent to or received from the Router Node 26 via wireless transmission of various wave types 22. One example of a wave type is radio frequency. Data storage is an integral part of each electronics subassembly package (examples include but are not limited to Sensor(s) 14, RFID Tag 16 and GPS 18).

In FIG. 2, Power Device 12 is supplied to all of the units shown (Sensor(s) 14, Radio Frequency Identification (RFID) Tag 16, Global Positioning System (GPS) 18 device, Router Node 26) by an on-board power source which includes a battery and a solar cell power/battery charger system. In some examples of marker electronics, power systems will also be an integral part of the electronics subassembly. Integration of the various power systems will be part of the assembly process. Additional power system embodiment examples would include fuel cells for distributed power.

In FIG. 2, Sensor(s) 14 data, RFID Tag 16 data and GPS 18 data and metadata are sent to or received from the Router Node 26 via wired or wireless connection. These data are then sent to or received from the Gateway Node 30 via transmission of various wave types 24. One example of a wave type is radio frequency. The Router Node 26 serves as a collection point for the data from or to the End Node 20, and as an extension for the range of the various wave type signals. Data are forwarded via Wireless 24 means to the Gateway Node 30. Data storage is an integral part of each electronics subassembly package (examples include but are not limited to Sensor(s) 14, RFID Tag 16 and GPS 18).

In FIG. 3, Power Device 12 is supplied to all of the units shown (Sensor(s) 14, Radio Frequency Identification (RFID) Tag 16, Global Positioning System (GPS) device 18, Gateway Node 30) by an on-board power source which includes a battery and a solar cell power/battery charger system. In some examples of marker electronics, power systems will also be an integral part of the electronics subassembly. Integration of the various power systems will be part of the assembly process. Additional power system embodiment examples would include fuel cells for distributed power.

In FIG. 3, Sensor(s) 14 data, RFID Tag 16 data and GPS 18 data and metadata are sent to or received from the Gateway Node 30 via wired or wireless connection. These data are then sent to or received from the Internet Gateway or Computer Control System 32 via transmission of various wave types 22. One example of a wave type is radio frequency. The Gateway Node 30 serves as the connection point for the data to get to or from the Internet. Data storage is an integral part of each electronics subassembly package (examples include but are not limited to Sensor(s) 14, RFID Tag 16 and GPS 18). The Wireless 28 connection transmits the data to or from the Internet Gateway or Computer Control System 32 in FIG. 4.

FIG. 4 depicts any computer system that has local control and/or access to the Internet.

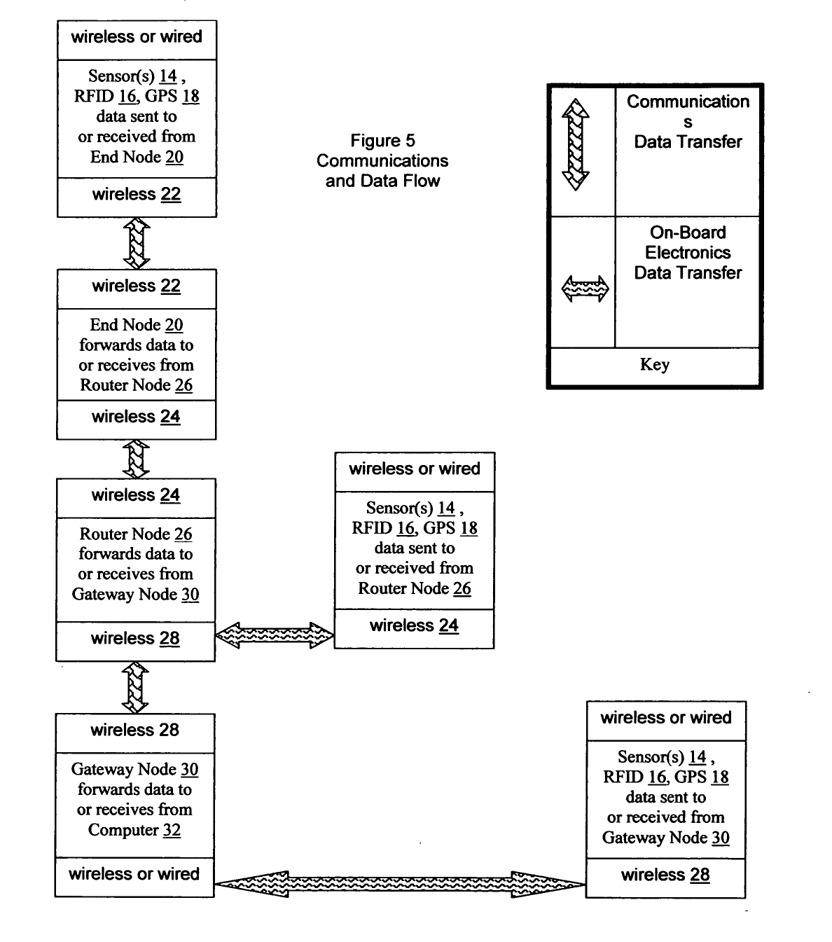

FIG. 5 Communications and Data Flow further demonstrates the primary embodiment communications and data flow paths and directions for the Internet-enabled, auto-networking, wireless, sensor-capable, specific geographic location marker based communications network system. FIG. 5's flow diagram reflects the two data paths: the wireless communications data transfer between the network nodes (examples are, but are not limited to End Node 20, Router Node 26, and Gateway Node 30); and the on-board internal-to-each-marker electronics data transfer of information coming from or to the various electronic components included in each stand-alone marker (examples include, but are not limited to, Sensor(s) 14, RFID 16, and GPS 18).

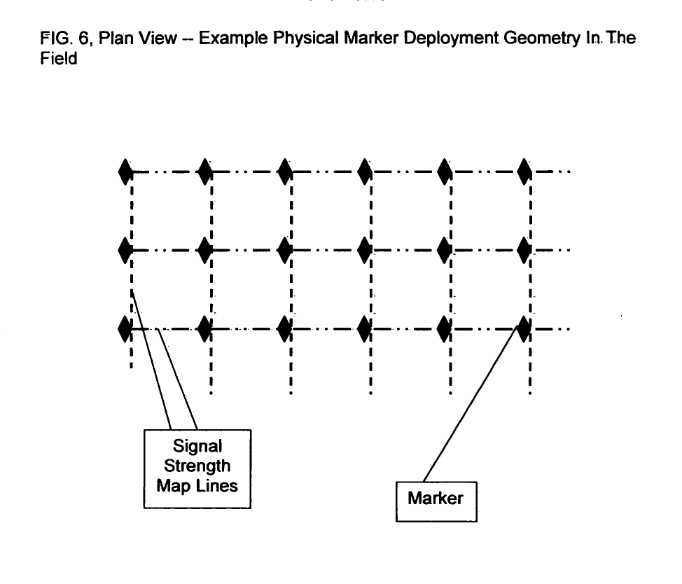

FIG. 6 Plan View—Example—Physical Marker Deployment Geometry In The Field, depicts one network communications geometry example. Signal strength mapping 36 in the deployment location will provide a customer-specific geometry for the various wireless communication nodes 34 (end, router, or gateway). Customer-specific requirements will also dictate the number and type of wireless communications nodes deployed in any given location as well as the number and type of electronics units assembled in each (sensors, GPS, RFID).

In use, it can now be understood that a Internet-enabled, auto-networking, wireless, sensor-capable, specific geographic location marker based communications network system is a significant enhancement to the security and well-being of humanity. The current methods for obtaining: bioinformatics; autonomous vehicle scenes; plat/tax data; topographic and control point photogrammetry data; environmental, industrial, commercial, residential, medical and security sensor data, and survey monument information are time consuming and can produce inaccurate or incomplete information—or they are currently impossible.

While a preferred embodiment of the Internet-enabled, auto-networking, wireless, sensor-capable, specific geographic location marker based communications network system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An Internet-enabled, auto-networking, wireless, sensor-capable, specific geographic location marker based communications network system for mobile or stationary device(s) or vehicle(s) through wired or wireless means.

2. The Internet-enabled, auto-networking, wireless, sensor-capable, specific geographic location marker based communications network system of claim 1 with the marker made of a material selected from the group consisting of concrete, metal and plastic.

3. The Internet-enabled, auto-networking, wireless, sensor-capable, specific geographic location marker based communications network system of claim 1 consisting of one of the following wireless communications network units; end node, router node, or gateway node.

4. The Internet-enabled, auto-networking, wireless, sensor-capable, specific geographic location marker based communications network system of claim 3 to include end node hardware acting as the end wireless communications network location for sending data to or receiving data from any field electronics.

5. The Internet-enabled, auto-networking, wireless, sensor-capable, specific geographic location marker based communications network system of claim 3 to include router node hardware that extend the data transmission distance or range of said communications network system.

6. The Internet-enabled, auto-networking, wireless, sensor-capable, specific geographic location marker based communications network system of claim 3 to include gateway node hardware that provide the connection to the Internet for data reception, transmission, compilation and analysis of said communications network system.

7. The Internet-enabled, auto-networking, wireless, sensor-capable, specific geographic location marker based communications network system of claim 1 to include all associated software to perform the networking, communications, data storage, security and analysis of end node hardware, router node hardware, and gateway node hardware of said communications network system.

8. The Internet-enabled, auto-networking, wireless, sensor-capable, specific geographic location marker based communications network system of claim 1 to include a geographic positioning (GPS) hardware system and associated software to bring its/their data to the wireless communications end node, router node or gateway node with or without security control of said communications network system.

9. The Internet-enabled, auto-networking, wireless, sensor-capable, specific geographic location based communications network system of claim 1 to include sensor(s) hardware and associated software to bring its/their data to the wireless communications end node, router node or gateway node with or without security control of said communications network system.

10. The Internet-enabled, auto-networking, wireless, sensor-capable, specific geographic location marker based communications network system of claim 1 to include a radio frequency identification tag (RFID) hardware and associated software to bring its/their data to the wireless communications end node, router node or gateway node with or without security control of said communications network system and that is active (powered) or passive (non-powered) and contains data storage capability for its own or system use for said communications network system.

11. The Internet-enabled, auto-networking, wireless, sensor-capable, specific geographic location marker based communications network system of claim 1 to include an internal and/or external power unit and associated software to bring its/their power to the on-board electronics and wireless communications end node, router node or gateway node with or without security control for said communications network system that is a battery and/or a solar cell based energy system for marker power.

12. The Internet-enabled, auto-networking, wireless, sensor-capable, specific geographic location marker based communications network system of claim 1 to include a method of obtaining information about a location of land including but not limited to the steps of: transmitting said data from the wireless communications end node to or from a wireless communications router node to or from a wireless communications gateway node to or from the Internet with all associated software; processing the communications wave signal to obtain the information about the location; and converting the information with computer software into a program language.

13. The Internet-enabled, auto-networking, wireless, sensor-capable, specific geographic location marker based communications network system of claim 1 to include a method of obtaining information about bioinformatics data from or to living organisms in real time including but not limited to the steps of: transmitting or receiving said data from the wireless communications end node to or from a wireless communications router node to or from a wireless communications gateway node to or from the Internet; processing the communications wave signal to obtain the information about the data; and converting the information with computer software into a program language.

14. The Internet-enabled, auto-networking, wireless, sensor-capable, specific geographic location marker based communications network system of claim 1 to include a method of obtaining information about route and environmental data for real time autonomous systems control including but not limited to the steps of: transmitting or receiving said data from the wireless communications end node to or from a wireless communications router node to or from a wireless communications gateway node to or from the Internet; processing the communications wave signal to obtain the information about the data; and converting the information with computer software into a program language.

15. The Internet-enabled, auto-networking, wireless, sensor-capable, specific geographic location marker based communications network system of claim 1 to include a method of obtaining information about plat data as the basis for tax assessment within the county auditor system of each state including but not limited to the steps of: transmitting or receiving said data from the wireless communications end node to or from a wireless communications router node to or from a wireless communications gateway node to or from the Internet; processing the communications wave signal to obtain the information about the data; and converting the information with computer software into a program language.

16. The Internet-enabled, auto-networking, wireless, sensor-capable, specific geographic location marker based communications network system of claim 1 to include a method of obtaining information about topographic and control point data for automating photogrammetry including but not limited to the steps of: transmitting or receiving said data from the wireless communications end node to or from a wireless communications router node to or from a wireless communications gateway node to or from the Internet; processing the communications wave signal to obtain the information about the data; and converting the information with computer software into a program language.

17. The Internet-enabled, auto-networking, wireless, sensor-capable, specific geographic location marker based communications network system of claim 1 to include a method of obtaining information about environmental, industrial, commercial, residential, medical and security sensor based data in real time including but not limited to the steps of: transmitting or receiving said data from the wireless communications end node to or from a wireless communications router node to or from a wireless communications gateway node to or from the Internet; processing the communications wave signal to obtain the information about the data; and converting the information with computer software into a program language.
